(19) United States
(12) Patent Application Publication
(10) Pub. No.: US 2025/0303780 A1
(43) Pub. Date: Oct. 2, 2025

(54) Carpenter Pencil Clip Device

(71) Applicant: Thomas Seidelmann, Saint Louis, MO (US)

(72) Inventor: Thomas Seidelmann, Saint Louis, MO (US)

(21) Appl. No.: 18/664,467

(22) Filed: May 15, 2024

Related U.S. Application Data
(60) Provisional application No. 63/571,127, filed on Mar. 28, 2024.

(51) Int. Cl. B43K 25/02

(52) U.S. Cl. CPC B43K 25/024

(57) ABSTRACT

A carpenter pencil clip device is disclosed that attaches onto an end of the pencil and onto a pant or shirt pocket. The carpenter pencil clip device comprises a body component that is configured to form around an edge of the pencil. The body component also comprises a protruding spring clip which secures the pencil to a user's pocket. Further, the body component is typically constructed using a malleable metal, such as aluminum, to tightly secure the obscure shape of the carpenter's pencil. Thus, the body component is bent and formed around the edge of the pencil and then clipped onto the user's pocket for storage and easy access.

### CROSS-REFERENCE TO RELATED APPLICATION

The present application claims priority to, and the benefit of, U.S. Provisional Application No. 63/571,127, which was filed on Mar. 28, 2024, and is incorporated herein by reference in its entirety.

### FIELD OF THE INVENTION

The present invention relates generally to the field of carpenter pencil clip devices. More specifically, the present invention relates to a flexible aluminum clip capable of holding a carpenter pencil in place on a pants or shirt pocket. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in carpenter pencil clip devices. Generally, carpenter pencils have two wide, flat sides to prevent them from rolling. Further, the graphite core is generally wide and flat, making it easy to mark coarse materials when using the flat side, while using the thinner side for precision marks. However, the pencil may fall out of a pocket or toolbelt without it being secured. Additionally, the pencil can fall without the owner knowing, and it could break or get lost.

A tradesman or handyman normally holds a carpenter's pencil behind their ear, in their front or back pocket or in the band of their hat. This pencil clip allows a tradesman the consistency of having the pencil at their side throughout the project. This saves time and the frustration of the lead of the pencil always breaking, and always looking for their pencil. However, retaining the pencil behind their ear or in a pocket makes it easy for the pencil to fall out, break and/or get lost.

Accordingly, there is a demand for an improved carpenter pencil clip device that provides users with a clip for holding their carpenter pencil in place. More particularly, there is a demand for a carpenter pencil clip device that keeps the pencil easily accessible but prevents it from being dropped or lost.

Therefore, there exists a long felt need in the art for a carpenter pencil clip device that provides users with a flexible aluminum clip capable of holding a carpenter pencil in place on a pants or shirt pocket. There is also a long felt need in the art for a carpenter pencil clip device that allows users to adjust the metal clip to securely wrap around the pencil and prevent it from being dropped or lost. Further, there is a long felt need in the art for a carpenter pencil clip device that keeps the pencil easily accessible for making measurement marks at any desired time. Moreover, there is a long felt need in the art for a device that offers ease and convenience to any carpenter that uses carpenter-style pencils on a worksite. Further, there is a long felt need in the art for a carpenter pencil clip device that is typically manufactured of aluminum. Finally, there is a long felt need in the art for a carpenter pencil clip device that is bent and formed around an edge of the pencil and then clipped onto the user's pocket for storage and easy access.

The subject matter disclosed and claimed herein, in one embodiment thereof, comprises a carpenter pencil clip device. The device is a slide-on clip that attaches onto an end of the pencil and onto a pant or shirt pocket. The carpenter pencil clip device comprises a body component that is configured to form around an edge of the pencil. The body component also comprises a protruding spring clip which secures the pencil to a user's pocket. Further, the body component is typically constructed using a malleable metal, such as aluminum, to tightly secure the obscure shape of the carpenter's pencil. Thus, the body component is bent and formed around the edge of the pencil and then clipped onto the user's pocket for storage and easy access.

In this manner, the carpenter pencil clip device of the present invention accomplishes all of the forgoing objectives and provides users with a device that secures a carpenter pencil to a user's pocket for storage and access. The device secures around an edge of a pencil and includes a spring clip. The device can be manufactured of aluminum.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a carpenter pencil clip device. The device is a slide-on clip that attaches onto an end of the pencil and onto a pant or shirt pocket. The carpenter pencil clip device comprises a body component that is configured to form around an edge/end of the pencil. The body component also comprises a spring clip which secures the pencil to a user's pocket. Thus, the body component is bent and formed around the edge/end of the pencil and then clipped onto the user's pocket for storage and easy access.

In one embodiment, the carpenter pencil clip device allows a user to releasably secure a carpenter pencil to their pocket. The pocket can be a pant pocket or a shirt pocket, or any other suitable place to secure the pencil. The device keeps a carpenter pencil easily accessible and secure. Further, carpenters' pencils typically measure approximately ¼ inch×½ inch×7 inches. They have a rectangular or elliptical shape, but can be any suitable size and shape as is known in the art. They have a blunt point on one end for marking, and a sharpened point on the other for drawing fine lines.

In one embodiment, the carpenter pencil clip device comprises a body component with an elongated spring clip. Typically, the body component comprises a tubular configuration, such that a length wraps around an end of the pencil. The length is wrapped end to end with the opposing ends, just touching and typically no overlap of the ends. The ends can be pulled apart then placed over the end of the pencil and pushed back together, effectively clamping the body component around the pencil for use. Typically, the length of the body component is dimensioned to encompass the perimeter of the end of the pencil and fit tightly around the end. With this arrangement, the body component is securely retained in a fixed position to the end of the pencil and lateral movement is prevented.

In one embodiment, the body component is adapted to receive a carpenter pencil, which is moved laterally into the body component. In another embodiment, the body component is pulled apart via the opposing ends, which are sufficiently placed around the pencil perimeter and then pressed together. Thus, the body component is sufficient to hold the same regardless of the size of the pencil.

In one embodiment, the spring clip comprises an elongated body which has a clamping tip portion thereof bent and turned down (or slightly under) to engage a support, such as a pocket wall between the portion of the spring clip and the pencil to which the spring clip is attached. Thus, the clamping tip portion engages a fabric therebetween, such as a pocket. A spring clip is typically soldered onto the body component at several points of contact therewith, or otherwise suitably held therein. Accordingly, the spring clip holds the device in place on a user's pocket. Specifically, the spring clip is arranged to extend down from the body component, with the clamping tip portion curving toward the pencil body and so dimensioned to spring back and then fit tightly against a user's pocket and the pencil body, to hold the pencil and device in place on a user's pocket.

As previously stated, the carpenter pencil clip device just described is shown by way of illustrative example as being mounted on a carpenter pencil. It is to be understood, however, that the device is equally adaptable to other suitable implements. All that is required is that the implements comprise an elongated body for securing the device to an end. It is to be noted further that the device may be attached to pens or other suitable devices, and accordingly no limitation is to be inferred from the illustrative teachings.

In one embodiment, the body component and the spring clip are constructed from thin resilient sheet metal of any suitable malleable metal, such as aluminum, which allows the body component to be bent and wrapped around an end of the pencil. The body component comprises an elongated strip having opposing ends. The aluminum also allows the spring clip to spring back and then fit tightly against a user's pocket and the pencil body, during use.

In one embodiment, the underneath or interior section of the spring clip comprises a plurality of teeth, which teeth are adapted to bite into the cloth so as to secure the device against the outer wall of a user's pocket and prevent accidental removal after the device has been clipped upon the outer wall of the pocket. The plurality of teeth are secured to an underside/interior section of the spring clip, thus the plurality of teeth are disposed such that they contact an inner side of the pocket during use. Due to the curvature of the spring clip, the cloth of the pocket is forced outwardly against the teeth during use.

In use, the body component is adapted to receive a carpenter pencil and is secured around a perimeter of the pencil end. Further, the body component may be pulled apart via the opposing ends, to sufficiently be placed around the pencil perimeter. The device is then attached to the pocket by the spring clip being pulled away from the pencil body and pushed downwardly upon the wall of the pocket, with said wall engaging between the interior of the spring clip and the pencil body. Thus, a pen or pencil after being inserted into the device, may be quickly and easily removed from the pocket for use via pulling the pencil straight upwardly and releasing the spring clip from the pocket wall.

In yet another embodiment, the carpenter pencil clip device comprises a plurality of indicia.

In yet another embodiment, a method of retaining a carpenter pencil for storage and easy access is disclosed. The method includes the steps of providing a carpenter pencil clip device comprising a body component with a spring clip. The method also comprises inserting a carpenter pencil within the body component, such that the body component forms around an edge of the pencil. Further, the method comprises securing the device and pencil to a user's pocket via the spring clip. Finally, the method comprises working with the device and pencil secured to a user's pocket until the pencil is needed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the carpenter pencil clip device of the present invention showing the device in accordance with the disclosed architecture;

FIGS. 2A-B illustrate a perspective view of one embodiment of the carpenter pencil clip device of the present invention showing the device in use in a shirt pocket in accordance with the disclosed architecture;

FIG. 3 illustrates a perspective view of one embodiment of the carpenter pencil clip device of the present invention showing the device attached to an edge of the pencil in accordance with the disclosed architecture;

FIG. 4 illustrates a perspective view of one embodiment of the carpenter pencil clip device of the present invention showing the device on a carpenter pencil in accordance with the disclosed architecture;

FIG. 5 illustrates a perspective view of one embodiment of the carpenter pencil clip device of the present invention showing the device in use in a pants pocket in accordance with the disclosed architecture; and

FIG. 6 illustrates a flowchart showing the method of retaining a carpenter pencil for storage and easy access in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a carpenter pencil clip device that provides users with a flexible aluminum clip capable of holding a carpenter pencil in place on a pants or shirt pocket. There is also a long felt need in the art for a carpenter pencil clip device that allows users to adjust the metal clip to securely wrap around the pencil and prevent it from being dropped or lost. Further, there is a long felt need in the art for a carpenter pencil clip device that keeps the pencil easily accessible for making measurement marks at any desired time. Moreover, there is a long felt need in the art for a device that offers ease and convenience to any carpenter that uses carpenter-style pencils on a worksite. Further, there is a long felt need in the art for a carpenter pencil clip device that is typically manufactured of aluminum. Finally, there is a long felt need in the art for a carpenter pencil clip device that is bent and formed around an edge of the pencil and then clipped onto the user's pocket for storage and easy access.

The present invention, in one exemplary embodiment, is a novel carpenter pencil clip device. The carpenter pencil clip device comprises a body component that is configured to form around an edge of the pencil. The body component also comprises a protruding spring clip which secures the pencil to a user's pocket. Further, the body component is typically constructed using a malleable metal, such as aluminum, to tightly secure the obscure shape of the carpenter's pencil. Thus, the body component is bent and formed around the edge of the pencil and then clipped onto the user's pocket for storage and easy access. The present invention also includes a novel method of retaining a carpenter pencil for storage and easy access. The method includes the steps of providing a carpenter pencil clip device comprising a body component with a spring clip. The method also comprises inserting a carpenter pencil within the body component, such that the body component forms around an edge of the pencil. Further, the method comprises securing the device and pencil to a user's pocket via the spring clip. Finally, the method comprises working with the device and pencil secured to a user's pocket until the pencil is needed.

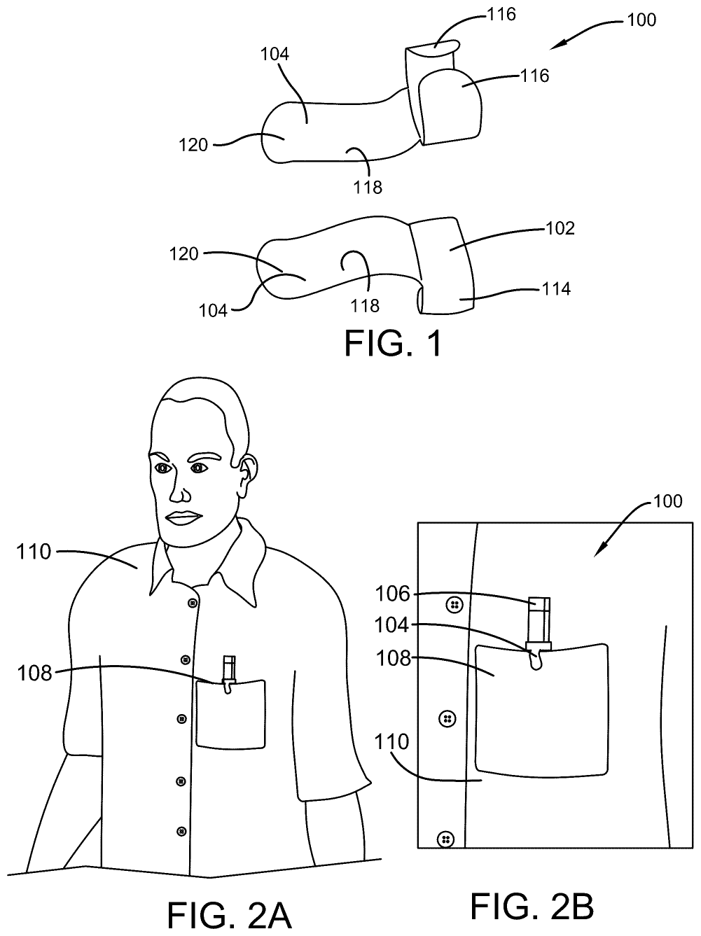

Referring initially to the drawings, FIG. 1 illustrates a perspective view of one embodiment of the carpenter pencil clip device 100 of the present invention. In the present embodiment, the carpenter pencil clip device 100 is an improved carpenter pencil clip device 100 that provides a user 110 with a slide-on clip for securing a carpenter pencil 106 to a pocket 108. Specifically, the carpenter pencil clip device 100 comprises a body component 102 with a spring clip 104, which is secured to a user's pocket 108. Thus, the body component 102 is bent and formed around the edge/end 112 of the pencil 106 and then clipped onto the user's pocket 108 for storage and easy access.

Generally, the carpenter pencil clip device 100 allows a user 110 to releasably secure a carpenter pencil 106 to their pocket 108. The pocket 108 can be a pant pocket or a shirt pocket, or any other suitable place to secure the pencil 106. The device 100 keeps a carpenter pencil 106 easily accessible and secure. Further, carpenters' pencils 106 typically measure approximately ¼ inch×½ inch×7 inches. They have a rectangular or elliptical shape, but can be any suitable size and shape as is known in the art. They have a blunt point on one end for marking, and a sharpened point on the other for drawing fine lines.

Further, the carpenter pencil clip device 100 comprises a body component 102 with an elongated spring clip 104. Typically, the body component 102 comprises a tubular configuration, such that a length 114 wraps around an end 112 of the pencil 106. The length 114 is wrapped end to end with the opposing ends 116, just touching and typically no overlap of the ends 116. The ends 116 can be pulled apart then placed over the end 112 of the pencil 106 and pushed back together, effectively clamping the body component 102 around the pencil 106 for use. Typically, the length 114 of the body component 102 is dimensioned to encompass the perimeter of the end 112 of the pencil 106 and fit tightly around the end 112. With this arrangement, the body component 102 is securely retained in a fixed position to the end 112 of the pencil 106 and lateral movement is prevented.

Additionally, the spring clip 104 comprises an elongated body 118 which has a clamping tip portion 120 thereof bent and turned down (or slightly under) to engage a support, such as a pocket 108 wall between the portion of the spring clip 104 and the pencil 106 to which the spring clip 104 is attached. Thus, the clamping tip portion 120 engages a fabric therebetween, such as a pocket 108. A spring clip 104 is typically soldered onto the body component 102 at several points of contact therewith, or otherwise suitably held therein. Accordingly, the spring clip 104 holds the device 100 in place on a user's pocket 108. Specifically, the spring clip 104 is arranged to extend down from the body component 102, with the clamping tip portion 120 curving toward the pencil body 106 and so dimensioned to spring back and then fit tightly against a user's pocket 108 and the pencil body 106, to hold the pencil 106 and device 100 in place on a user's pocket 108.

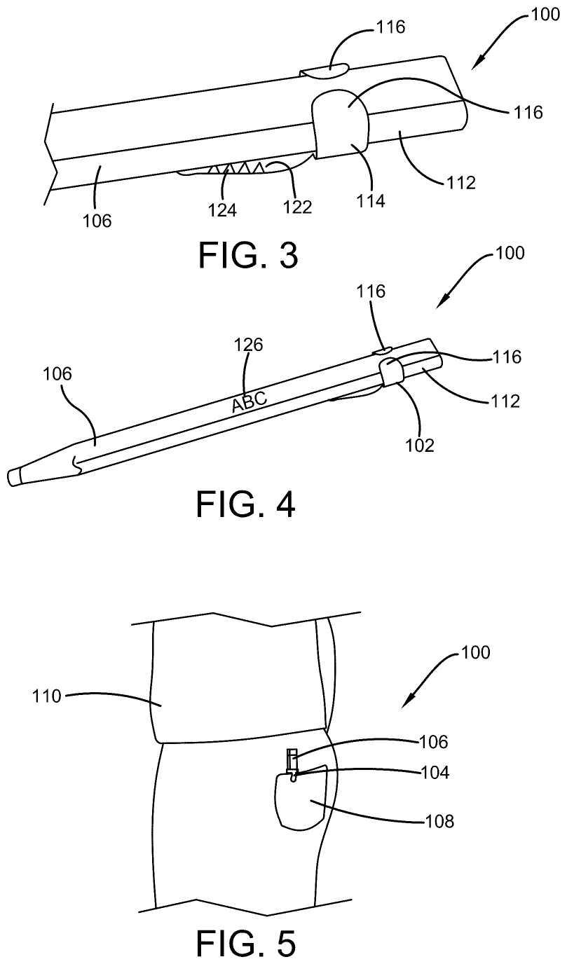

As shown in FIG. 3, the body component 102 is adapted to receive a carpenter pencil 106, which is moved laterally into the body component 102. In another embodiment, the body component 102 is pulled apart via the opposing ends 116, which are sufficiently placed around the pencil perimeter and then pressed together. Thus, the body component 102 is sufficient to hold the same regardless of the size of the pencil 106.

As previously stated, the carpenter pencil clip device 100 just described is shown by way of illustrative example as being mounted on a carpenter pencil 106. It is to be understood, however, that the device 100 is equally adaptable to other suitable implements. All that is required is that the implements comprise an elongated body for securing the device 100 to an end 112. It is to be noted further that the device 100 may be attached to pens or other suitable devices, and accordingly no limitation is to be inferred from the illustrative teachings.

Generally, the body component 102 and the spring clip 104 are constructed from thin resilient sheet metal of any suitable malleable metal, such as aluminum, which allows the body component 102 to be bent and wrapped around an end 112 of the pencil 106. The body component 102 comprises an elongated strip (i.e., length 114) having opposing ends 116. The aluminum also allows the spring clip 104 to spring back and then fit tightly against a user's pocket 108 and the pencil 106 body, during use.

As shown in FIG. 4, in one embodiment, the underneath or interior section 122 of the spring clip 104 comprises a plurality of teeth 124, which teeth 124 are adapted to bite into the cloth so as to secure the device 100 against the outer wall of a user's pocket 108 and prevent accidental removal after the device 100 has been clipped upon the outer wall of the pocket 108. The plurality of teeth 124 are secured to an underside/interior section 122 of the spring clip 104, thus the plurality of teeth 124 are disposed such that they contact an inner side of the pocket 108 during use. Due to the curvature of the spring clip 104, the cloth of the pocket 108 is forced outwardly against the teeth 124 during use.

In yet another embodiment, the carpenter pencil clip device 100 comprises a plurality of indicia 126. The body component 102 of the device 100 may include advertising, a trademark, or other letters, designs, or characters, printed, painted, stamped, or integrated into the body component 102, or any other indicia 126 as is known in the art. Specifically, any suitable indicia 126 as is known in the art can be included, such as but not limited to, patterns, logos, emblems, images, symbols, designs, letters, words, characters, animals, advertisements, brands, etc., that may or may not be carpenter pencil, pocket, or brand related.

As shown in FIGS. 2A-B and 5, in use, the body component 102 is adapted to receive a carpenter pencil 106 and is secured around a perimeter of the pencil end 112. Further, the body component 102 may be pulled apart via the opposing ends 116, to sufficiently be placed around the pencil 106 perimeter. The device 100 is then attached to the pocket 108 by the spring clip 104 being pulled away from the pencil body 106 and pushed downwardly upon the wall of the pocket 108, with said wall engaging between the interior 122 of the spring clip 104 and the pencil body 106. Thus, a pen or pencil 106 after being inserted into the device 100, may be quickly and easily removed from the pocket 108 for use via pulling the pencil 106 straight upwardly and releasing the spring clip 104 from the pocket 108 wall.

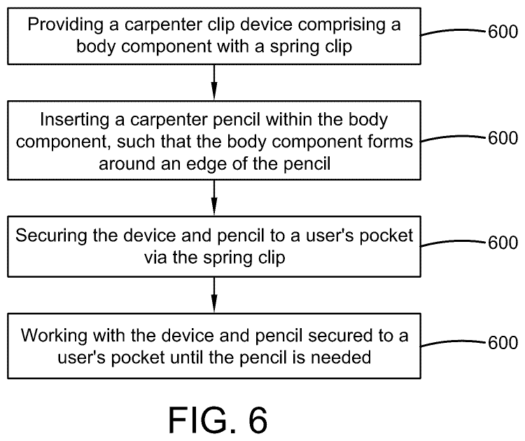

FIG. 6 illustrates a flowchart of the method of retaining a carpenter pencil for storage and easy access. The method includes the steps of at 600, providing a carpenter pencil clip device comprising a body component with a spring clip. The method also comprises at 602, inserting a carpenter pencil within the body component, such that the body component forms around an edge of the pencil. Further, the method comprises at 604, securing the device and pencil to a user's pocket via the spring clip. Finally, the method comprises at 606, working with the device and pencil secured to a user's pocket until the pencil is needed.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “carpenter pencil clip device”, “carpenter pencil device”, “clip device”, and “device” are interchangeable and refer to the carpenter pencil clip device 100 of the present invention.

Notwithstanding the forgoing, the carpenter pencil clip device 100 of the present invention can be of any suitable size and configuration as is known in the art without affecting the overall concept of the invention, provided that it accomplishes the above stated objectives. One of ordinary skill in the art will appreciate that the carpenter pencil clip device 100 as shown in FIGS. 1-6 is for illustrative purposes only, and that many other sizes and shapes of the carpenter pencil clip device 100 are well within the scope of the present disclosure. Although the dimensions of the carpenter pencil clip device 100 are important design parameters for user convenience, the carpenter pencil clip device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A carpenter pencil clip device that provides a user with a slide-on clip for securing a carpenter pencil to a pocket, the carpenter pencil clip device comprising:
a body component; and
a spring clip; and
wherein the spring clip is secured to the body component;
wherein the body component is secured around an end of a carpenter pencil; and
further wherein the body component, the carpenter pencil, and the spring clip are secured to a user's pocket for storage and easy access of the carpenter pencil.

2. The carpenter pencil clip device of claim 1, wherein the user's pocket is a pant pocket or a shirt pocket.

3. The carpenter pencil clip device of claim 2, wherein the body component comprises a tubular configuration, such that a length wraps around the end of the carpenter pencil.

4. The carpenter pencil clip device of claim 3, wherein the length is wrapped end to end with opposing ends, just touching and typically no overlap of the opposing ends.

5. The carpenter pencil clip device of claim 4, wherein the opposing ends can be pulled apart then placed over the end of the carpenter pencil and pushed back together, effectively clamping the body component around the carpenter pencil for use.

6. The carpenter pencil clip device of claim 5, wherein the length of the body component is dimensioned to encompass a perimeter of the end of the carpenter pencil.

7. The carpenter pencil clip device of claim 6, wherein the spring clip comprises an elongated body which has a clamping tip portion that is bent and turned down to engage the user' pocket.

8. The carpenter pencil clip device of claim 7, wherein the clamping tip portion engages the user's pocket and sandwiches the user's pocket between the clamping tip portion and the carpenter pencil.

9. The carpenter pencil clip device of claim 8, wherein the spring clip is soldered onto the body component.

10. The carpenter pencil clip device of claim 9, wherein the spring clip extends down from the body component, with the clamping tip portion curving toward the carpenter pencil and so dimensioned to spring back and then fit tightly against the user's pocket and the carpenter pencil.

11. The carpenter pencil clip device of claim 10, wherein the body component and the spring clip are constructed from aluminum.

12. A carpenter pencil clip device that provides a user with a slide-on clip for securing a carpenter pencil to a pocket, the carpenter pencil clip device comprising:
a body component; and
a spring clip; and
wherein the body component comprises a tubular configuration, such that a length wraps around the end of the carpenter pencil;
wherein the length is wrapped end to end with opposing ends, just touching and typically no overlap of the opposing ends;
wherein the length of the body component is dimensioned to encompass a perimeter of the end of the carpenter pencil;
wherein the spring clip comprises an elongated body which has a clamping tip portion that is bent and turned down to engage the user' pocket;
wherein the spring clip is soldered onto the body component;
wherein the clamping tip portion engages the user's pocket and sandwiches the user's pocket between the clamping tip portion and the carpenter pencil;
wherein the spring clip extends down from the body component, with the clamping tip portion curving toward the carpenter pencil and so dimensioned to spring back and then fit tightly against the user's pocket and the carpenter pencil; and
further wherein the carpenter pencil clip device is secured to a user's pocket for storage and easy access of the carpenter pencil.

13. The carpenter pencil clip device of claim 12, wherein the body component and the spring clip are constructed from aluminum.

14. The carpenter pencil clip device of claim 12, wherein an interior section of the spring clip comprises a plurality of teeth.

15. The carpenter pencil clip device of claim 14, wherein the plurality of teeth are adapted to bite into the user's pocket, so as to secure the carpenter pencil clip device against an outer wall of the user's pocket and prevent accidental removal.

16. The carpenter pencil clip device of claim 12, wherein the body component is adapted to receive the carpenter pencil, which is moved laterally into the body component.

17. The carpenter pencil clip device of claim 12, wherein the body component is pulled apart via the opposing ends, which are sufficiently placed around a perimeter of the carpenter pencil and then pressed together.

18. The carpenter pencil clip device of claim 12 further comprising a plurality of indicia.

19. The carpenter pencil clip device of claim 12, wherein the user's pocket is a pant pocket or a shirt pocket.

20. A method of retaining a carpenter pencil for storage and easy access, the method comprising the following steps:
providing a carpenter pencil clip device comprising a body component with a spring clip; inserting a carpenter pencil within the body component, such that the body component forms around an edge of the pencil;
securing the device and pencil to a user's pocket via the spring clip; and
working with the device and pencil secured to a user's pocket until the pencil is needed.
